(19) United States
(12) Patent Application Publication
(10) Pub. No.: US 2025/0390330 A1
(43) Pub. Date: Dec. 25, 2025

(54) VIRTUAL SYSTEM MANAGEMENT SYSTEM

(71) Applicant: Hitachi Vantara, Ltd., Yokohama-shi (JP)

(72) Inventor: Kouta TOGAWA, Yokohama-shi (JP)

(73) Assignee: Hitachi Vantara, Ltd., Yokohama-shi, Kanagawa (JP)

(21) Appl. No.: 19/079,180

(22) Filed: Mar. 13, 2025

(30) Foreign Application Priority Data
Jun. 21, 2024 (JP) 2024-100606

(51) Int. Cl. G06F 9/455

(52) U.S. Cl. CPC G06F 9/45558; G06F 2009/45575

(57) ABSTRACT

A management system stores server management information and virtualization package management information. The server management information indicates a current output power value, a threshold for an output power value and a type of each of a plurality of physical servers. The virtualization package management information indicates a physical server on which a plurality of virtualization packages are installed and a type of each of the virtualization packages. The management system selects a control target server from the plurality of physical servers, and determines whether distribution of a virtualization package on the control target server to another physical server or aggregation of a virtualization package from another physical server to the control target server is necessary based on an output power value and the threshold of the control target server. When it is determined that the distribution or the aggregation is necessary, the management system selects a virtualization package which is a movement candidate and a physical server which is a movement destination candidate in the same group.

### CLAIM OF PRIORITY

The present application claims priority from Japanese patent application JP 2024-100606 filed on Jun. 21, 2024, the content of which is hereby incorporated by reference into this application.

### BACKGROUND OF THE INVENTION

### 1. Field of the Invention

The present invention relates to a virtual system management system.

### 2. Description of Related Art

JP2016-110240A (Patent Literature 1) is a background art of the present technical field. In Patent Literature 1, power control is implemented by the following rearrangement of a virtual machine. A physical server to be a rearrangement destination of the virtual machine that needs to be rearranged is determined according to a load amount variation and a change in a power supply state. For example, when a load on the physical server deviates from a predetermined range (a load lower limit threshold to a load upper limit threshold), the virtual machine deployed on the deviated physical server is rearranged on another physical server. In addition, control is performed to increase the number of servers in a standby off state.

### CITATION LIST

### Patent Literature

Patent Literature 1: JP2016-110240A

### SUMMARY OF THE INVENTION

An IT system using virtualization technology is the mainstream of the IT industry, and it is important to reduce power consumption without reducing processing capability of a server device. At this time, power loss caused by power conversion may occur in a power supply device in the server device, and extra power consumption may occur. However, Patent Literature 1 does not consider the power loss caused by power conversion of the power supply device, and unnecessary power consumption loss continues to occur. Further, although rearrangement is executed based on a load state of a virtual machine, there is room for improvement from the viewpoint of power consumption in the rearrangement.

According to an aspect of the invention, a management system for managing a virtualization system includes a processor and a storage device. The storage device stores server management information for managing a plurality of physical servers, and virtualization package management information for managing a plurality of virtualization packages that are installed on the plurality of physical servers and provide isolated user environments. The server management information indicates a current output power value of each of the plurality of physical servers, a threshold for an output power value of each of the plurality of physical servers, and a type of each of the plurality of physical servers. The virtualization package management information indicates a physical server on which each of the plurality of virtualization packages is installed, and a type of each of the plurality of virtualization packages. The processor is configured to select a control target server from the plurality of physical servers, acquire information on an output power value and a threshold of the control target server from the server management information, determine whether distribution of a virtualization package on the control target server to another physical server or aggregation of a virtualization package from another physical server to the control target server is necessary based on the output power value and the threshold of the control target server, and refer to the server management information and the virtualization package management information and select a virtualization package which is a movement candidate and a physical server which is a movement destination candidate in the same group when it is determined that the distribution or the aggregation of the virtualization package is necessary.

According to the aspect of the invention, a virtualization system can be more appropriately implemented.

### BRIEF DESCRIPTION OF THE DRAWINGS

FIG. 1A is a diagram illustrating an outline of an embodiment of the present specification.

FIG. 1B is a diagram illustrating an outline of the embodiment of the present specification.

FIG. 1C is a diagram illustrating an outline of the embodiment of the present specification.

FIG. 2 is a graph illustrating an example of a relationship between output power and power supply efficiency in a power supply device of a physical server.

FIG. 3 illustrates a configuration example of a management server.

FIG. 4 illustrates a configuration example of a server management table.

FIG. 5 illustrates a configuration example of a container management table.

FIG. 6 illustrates a configuration example of a part of a movement destination power transition management table.

FIG. 7 illustrates a configuration example of a movement source power transition management table.

FIG. 8 illustrates an overall flow of processing executed by the management server.

FIG. 9A illustrates a flowchart of type classification processing.

FIG. 9B illustrates the flowchart of the type classification processing.

FIG. 10 illustrates a flowchart of container arrangement optimization processing.

FIG. 11 illustrates a flowchart of threshold determination processing.

FIG. 12A illustrates a flowchart of load aggregation processing.

FIG. 12B illustrates a flowchart of the load aggregation processing.

FIG. 12C illustrates a flowchart of the load aggregation processing.

FIG. 13A illustrates a flowchart of load distribution processing.

FIG. 13B illustrates a flowchart of the load distribution processing.

FIG. 13C illustrates a flowchart of the load distribution processing.

FIG. 14 illustrates a flowchart of load distribution processing of a movement destination server.

### DESCRIPTION OF EMBODIMENTS

In the following embodiment, for the sake of convenience, description will be made by being divided into a plurality of sections or embodiments as needed, but unless otherwise stated, the sections or embodiments are not unrelated to one another, and one is a modification, details, supplementary description, and the like of a part or all of the other ones. Hereinafter, when referring to the number or the like of elements (including the number, a numerical value, an amount, a range, or the like), the number of elements is not limited to a specific number, and may be the specific number or more or the specific number or less, unless otherwise specified or except a case where the number is apparently limited to a specific number in principle.

A computer system can be implemented by one computer or a plurality of computers that can communicate with one another. A computer device, a computer system, or a computing resource group includes one or more interface devices (for example, including a communication device and an input and output device), one or more storage devices (for example, including a memory (a main storage) and an auxiliary storage device), and one or more processors.

When a function is implemented by executing a program by a processor, the function may be at least a part of the processor since specified processing is executed using a storage device and/or an interface device as appropriate. The processing described with a function as a subject may be processing executed by a processor or a system including the processor.

A program may be installed from a program source. The program source may be, for example, a program distribution computer or a computer-readable storage medium (for example, a computer-readable non-transitory storage medium). Description of functions is an example. A plurality of functions may be integrated into one function, or one function may be divided into a plurality of functions.

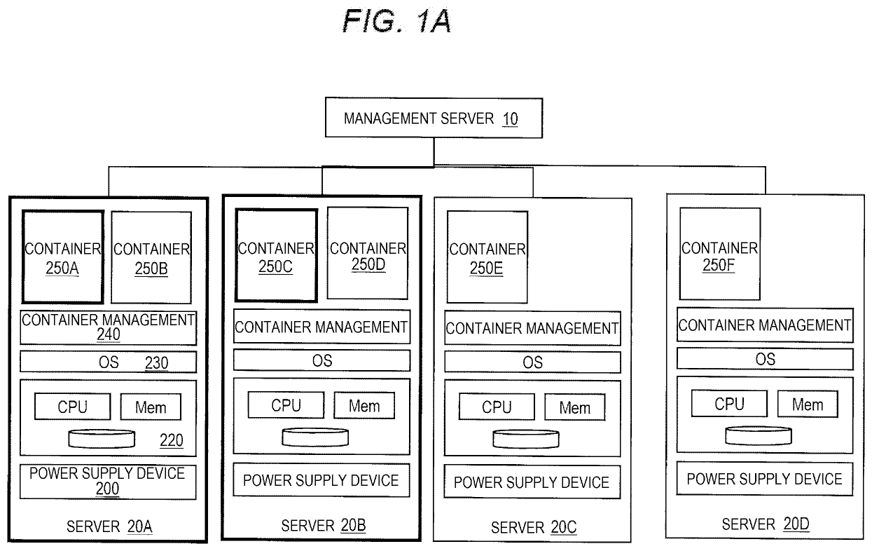

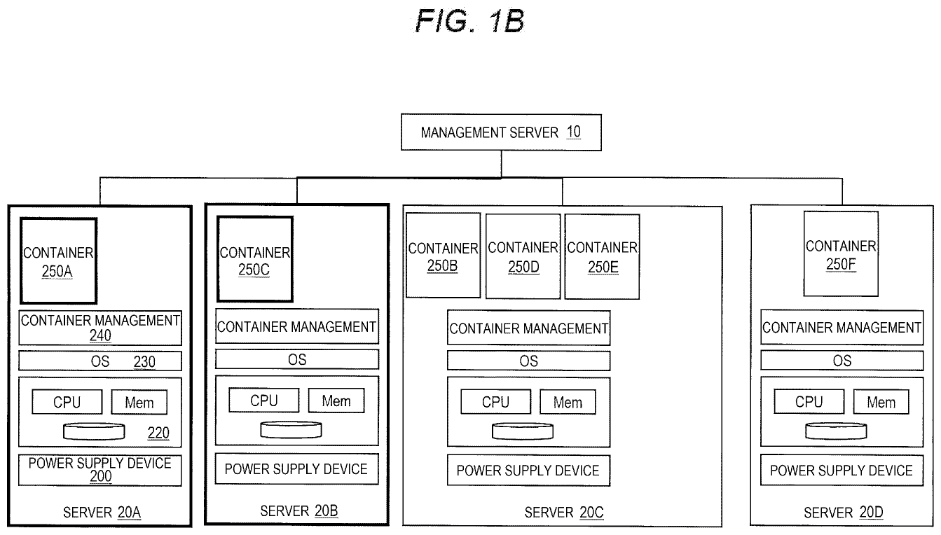

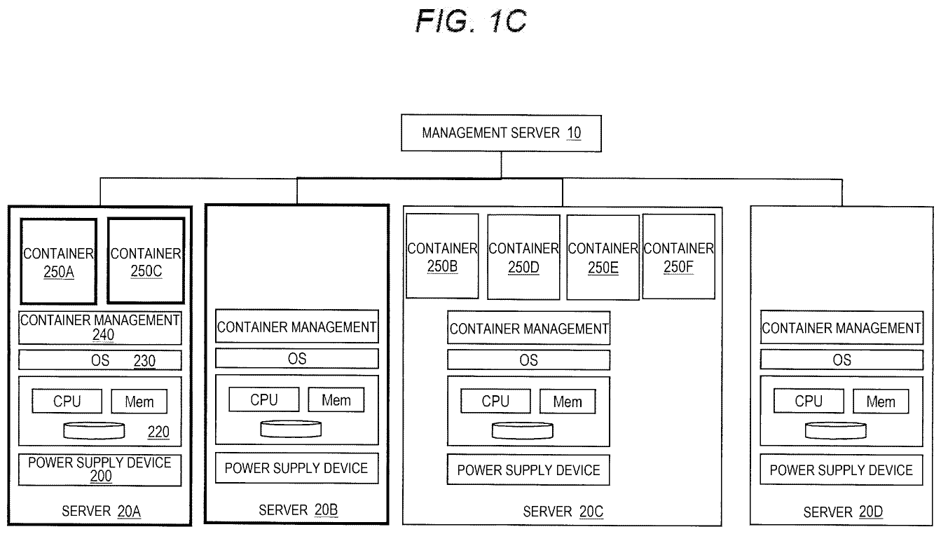

FIGS. 1A to 1C are diagrams illustrating an outline of an embodiment of the present specification. When a container or a virtual machine (a virtualization package) is operated on a plurality of servers, a management server 10 moves the virtualization package in accordance with a load state, thereby reducing power consumption. Focusing on power conversion efficiency of a power supply device, it is possible to achieve an operation in which desirable conversion efficiency is maintained and power loss caused by power conversion is prevented. The CO2 emission amount can be reduced by reducing power consumption.

In the embodiment of the present specification, a server and a virtualization package are grouped, and a movement range of the virtualization package is limited to the same group. Accordingly, it is possible to perform arrangement more suitable for a request of the virtualization package. Further, the movement of the virtualization package may cause temporary instability of power and processing performance. By limiting the movement range of the virtualization package, it is possible to prevent the number of times of movement of the virtualization package and achieve early stabilization of power and processing performance.

In the example in FIGS. 1A to 1C, the management server 10 manages and controls virtual systems of a plurality of physical servers (also simply referred to as servers). FIGS. 1A to 1C illustrate four management target servers 20A to 20D as an example. The management server 10 and the management target servers 20A to 20D are communicably connected via a network. These servers are applicable to an on-premise environment, a public cloud environment, and a hybrid cloud environment of an on-premise and a public cloud.

Each of the servers 20A to 20D includes a power supply device 200, a physical resource 220, an operating system (OS) 230, and a container management system 240. In FIGS. 1A to 1C, these elements of the server 20A are denoted by reference numerals as an example. Hereinafter, the server 20A will be described as an example.

The power supply device 200 supplies required power to each physical component of the server 20A. The physical resource 220 includes, for example, a processor, a memory, an auxiliary storage device, and a network. The server 20A executes the container management system 240 on the operating system 230.

The container management system 240 virtualizes the physical resource 220. The virtualization expresses a single resource of a system such as a memory, a CPU, an auxiliary storage device, and a network as a plurality of resources. Specifically, the container management system 240 divides each component (for example, a processor core) and a usage time, and allocates the divided component or usage time to one or more containers.

The container is a virtualization software package that provides an isolated application execution environment. Another example of the virtualization software package (a virtualization package or a virtualization resource) of such an isolated user environment is a virtual machine. As described above, the virtualization software package has a virtualization resource such as a processor and a memory to which a physical resource is allocated from the physical resource 220. An example of the container will be described below.

The management server 10 manages and controls movement of a container between servers. The servers 20A to 20D execute containers 250A to 250F. The servers 20A to 20D and the containers 250A to 250F are grouped. In the examples in FIGS. 1A to 1C, the servers 20A and 20B and the containers 250A and 250C constitute one group, and the servers 20C and 20D and the containers 250B and 250D constitute another group. A group may be set in advance by a user.

FIG. 1A illustrates an initial state. The server 20A executes the containers 250A and 250B, the server 20B executes the containers 250C and 250D, the server 20C executes the container 250E, and the server 20D executes the container 250F.

The management server 10 executes type classification processing on a container arrangement in the initial state, and then executes container arrangement optimization processing. FIG. 1B illustrates a container arrangement after the type classification processing is executed. In the type classification processing, containers arranged in servers of different groups are moved to servers of the same group.

In FIG. 1A, the containers 250B and 250D are respectively arranged in servers 20A and 20B of different groups. Therefore, as illustrated in FIG. 1B, the management server 10 moves the containers 250B and 250D to the server 20C of the same group. In the container arrangement illustrated in FIG. 1B, all containers are arranged on servers of each group.

Next, the management server 10 executes container arrangement optimization processing. The container arrangement optimization processing rearranges containers in each group according to a predetermined condition. FIG. 1C illustrates a container arrangement after the container arrangement optimization processing. The management server 10 moves the container 250C from the server 20B to the server 20A and moves the container 250F from the server 20D to the server 20C. The management server 10 turns off a power supply of the servers 20B and 20D in which there is no container to be executed.

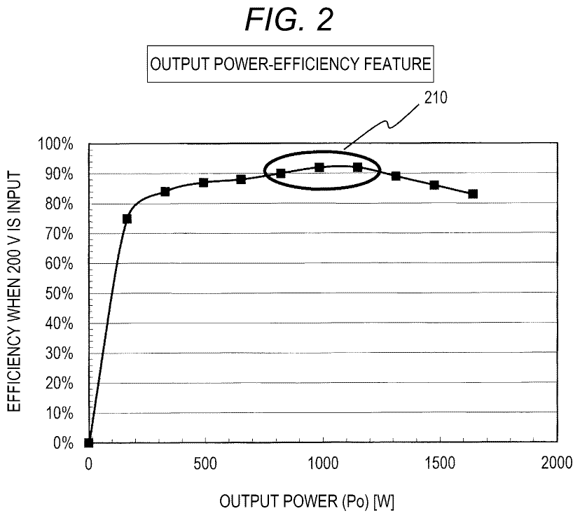

A user can set, for example, an output power range with high power conversion efficiency as a threshold A in the management server 10 based on specifications of the power supply device 200. FIG. 2 is a graph illustrating an example of a relationship between output power and power supply efficiency of the power supply device 200 of a physical server. A horizontal axis represents output power, and a vertical axis represents power supply efficiency. An input voltage is 200 V. As illustrated in FIG. 2, the power supply efficiency changes according to the output power. In the example illustrated in FIG. 2, higher power supply efficiency is illustrated in an output power range 210.

A user selects a desired output power range for each physical server, for example, a range indicating higher power supply efficiency, and sets the selected range in the management server 10. The management server 10 selects a server that executes a container based on the set output power range. Accordingly, the output power of each server can be brought close to a desired range.

A user may further set one or more thresholds for a physical resource of each server in order to ensure performance of each container. For example, a threshold B and a threshold C can be set for respective usage rates of a CPU and a memory of a physical server. The CPU usage rate and the memory usage rate are values each indicating a usage state of a physical resource.

For example, a user can set an appropriate threshold for each group. In an example to be described below, a performance priority group and a power saving priority group are defined. For example, upper limit values of the usage rates of the CPU and the memory in the performance priority group may be smaller than those in the power saving priority group.

The management server 10 stores management information for managing a physical server and a container, and manages and refers to the management information to monitor output power of each server, usage rates of a CPU and a memory of each server, and usage rates of a CPU and a memory of each container (allocated).

For example, when the power supply output, the CPU usage rate, and the memory usage rate of a certain server do not reach a threshold A, a threshold B, and a threshold C, respectively, the management server 10 aggregates containers from other servers to the server. At this time, the management server 10 may record the CPU usage rate and the memory usage rate of the moved container and a change in output power of a movement source and a movement destination in the management information, and use the management information in determination of subsequent container movement. Accordingly, more appropriate container movement can be performed.

The management server 10 may preferentially select a specific physical server as a movement source of a container, and the management server 10 may cut off a power supply of a server on which a container is absent due to container movement. By giving priority to a specific server, it is possible to increase the probability of occurrence of a server on which a container is absent, and it is possible to effectively reduce power consumption of a system.

On the other hand, when one or more of the output power, the CPU usage rate, and the memory usage rate of a certain server exceeds a corresponding threshold (including a range), the management server 10 moves one or more containers from the server to another server.

The management server 10 refers to the management information and estimates the output power, the CPU usage rate, and the memory usage rate when the container is moved to a movement destination candidate server. When an estimation result satisfies a threshold condition, the movement destination candidate server is determined as a movement destination. Accordingly, container arrangement can be performed more appropriately in terms of power consumption and performance. When the management server 10 cannot find a movement destination in servers whose power supply is turned on and there is a server whose power supply is turned off, the management server 10 turns on the power supply of the server and moves a container to the server. Accordingly, more appropriate container arrangement can be performed in the entire system.

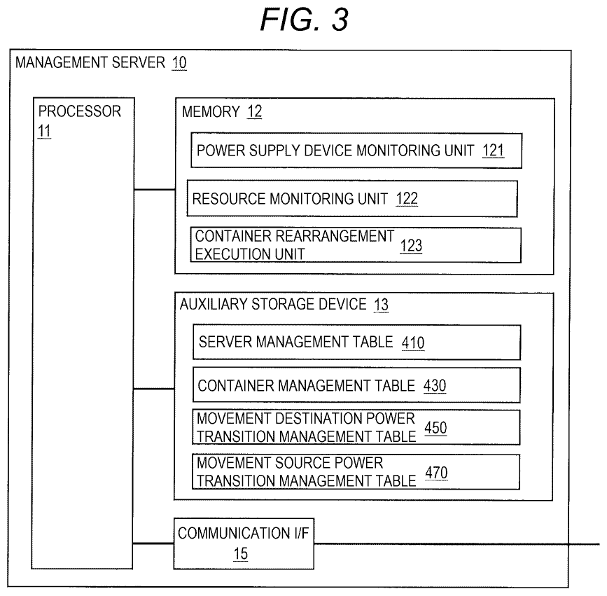

In the following, management and control of a virtualization system including a plurality of physical servers, which is performed by the management server 10, will be described more specifically. FIG. 3 illustrates a configuration example of the management server 10. The management server 10 includes a processor 11, a memory (main storage device) 12, an auxiliary storage device 13, and a communication interface 15 for communicating with other computer nodes via a network. These components communicate with one another via a bus.

The processor 11 is, for example, a CPU and may include one or more cores. The memory 12 is, for example, a DRAM which is a volatile storage device, and the auxiliary storage device 13 is, for example, a solid state drive (SSD) or a hard disk drive (HDD), which is a nonvolatile storage device. The number of components of the management server 10 is not particularly limited, and other components such as an input device and an output device may be provided. Examples of the input device include a keyboard and a mouse, and examples of the output device include a display device and a printer.

A program (a command code) executed by the processor 11 and information used by the program are stored in, for example, the auxiliary storage device 13 and loaded into the memory 12. The processor 11 implements a predetermined function by executing the program stored in the memory 12 (operating according to an instruction in the program). The processor 11 may include one or more processor units or processor cores. Other computer nodes may also include the above-described components. The number of these components is not particularly limited.

In the configuration example illustrated in FIG. 3, the memory 12 stores a plurality of programs to be executed by the processor 11. The programs include a power supply device monitoring unit 121, a resource monitoring unit 122, and a container rearrangement execution unit 123. The auxiliary storage device 13 stores management information for managing a server and a container. The management information includes a server management table 410, a container management table 430, a movement destination power transition management table 450, and a movement source power transition management table 470.

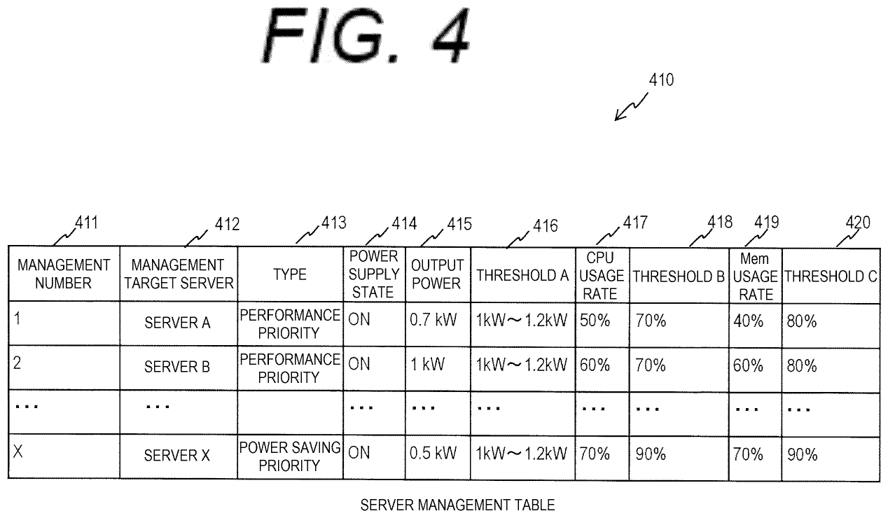

FIG. 4 illustrates a configuration example of the server management table 410. The server management table 410 manages information on physical servers managed by the management server 10. The information in the server management table 410 is, for example, periodically acquired from a server and updated.

The server management table 410 includes a management number column 411, a management target server column 412, a type column 413, a power supply state column 414, an output power column 415, a threshold A column 416, a CPU usage rate column 417, a threshold B column 418, a memory (Mem) column 419, and a threshold C column 420.

The management number column 411 illustrates a management number assigned to each management target server. Different management numbers are assigned to different servers. The management target server column 412 illustrates a name for uniquely identifying a management target server. The type column 413 illustrates a server type, and illustrates a group by grouping a server and a container. In this example, two types (groups) of performance priority type and a power saving priority type are defined. The power supply state column 414 illustrates a state of a power supply of each server, specifically, illustrates whether the server is turned on or turned off. The output power column 415 illustrates current output power of a power supply device of each server. The threshold A column 416 illustrates a range set in advance for the output power.

The CPU usage rate column 417 indicates a current CPU usage rate of a server. The threshold B column 418 illustrates a threshold set in advance for the CPU usage rate of a server. The memory (Mem) usage rate column 419 illustrates a current memory usage rate of a server. The threshold C column 420 illustrates a threshold set in advance for the memory usage rate of a server. Each of the thresholds A, B, and C indicates a specified range of a target. For example, the threshold A designates a desirable range of output power, and a range equal to or less than the threshold B and a range equal to or less than the threshold C designate desirable ranges from the viewpoint of processing performance.

For example, the threshold B of the CPU usage rate and the threshold C of the memory usage rate for a server of the performance priority type may be smaller than the threshold B of the CPU usage rate and the threshold C of the memory usage rate for a server of the power saving priority type (non-performance priority type).

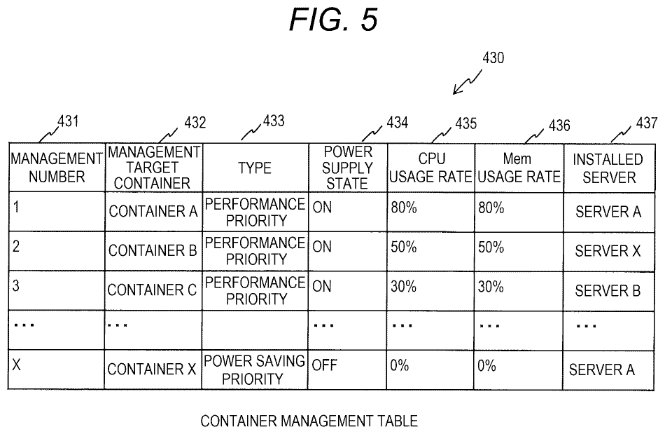

FIG. 5 illustrates a configuration example of the container management table 430. The container management table 430 is virtualization package management information for managing a container that is a virtualization package. The container management table 430 manages information on containers managed by the management server 10. The information in the container management table 430 is, for example, periodically acquired from a server and updated.

The container management table 430 includes a management number column 431, a management target container column 432, a type column 433, a power supply state column 434, a CPU usage rate column 435, a memory (Mem) usage rate column 436, and an installed server column 437.

The management number column 431 illustrates management number assigned to each management target container. Different management numbers are assigned to different containers. The management target container column 432 illustrates a name for uniquely identifying a management target container. The type column 433 illustrates a type of a container, and illustrates a group by grouping a server and a container. In this example, two types (groups) of a performance priority type and a power saving priority type are defined.

The power supply state column 414 illustrates a state of a power supply of a container, specifically, illustrates whether a container is turned on or turned off. The CPU usage rate column 435 illustrates a current CPU usage rate of a container. The memory (Mem) usage rate column 436 illustrates a current memory usage rate of a container. The installed server column 437 illustrates a name of a physical server on which a container is currently installed (executed).

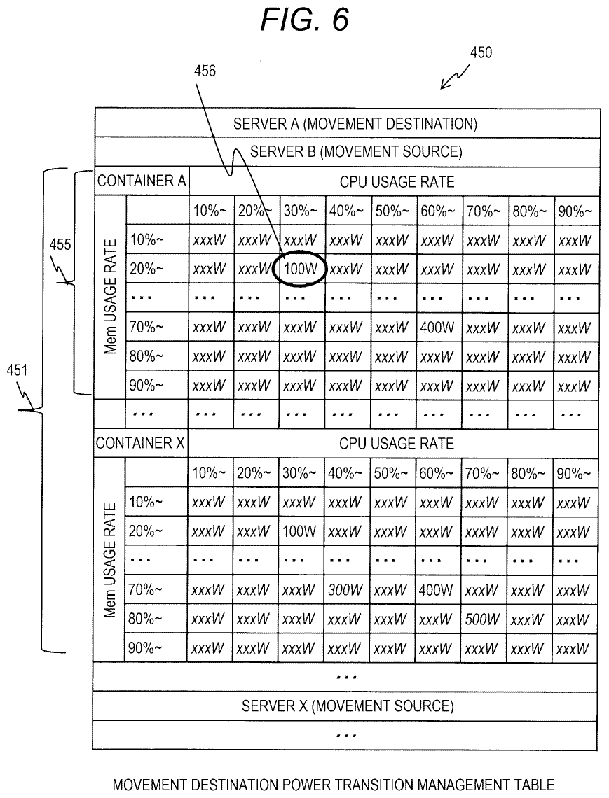

FIG. 6 illustrates a configuration example of a part of the movement destination power transition management table 450. The movement destination power transition management table 450 manages a change in output power of a movement destination server when a container is moved to the movement destination server. In this example, the movement destination power transition management table 450 stores an initial estimated value or an actually measured value of an output power change amount (difference) associated with container movement.

The movement destination power transition management table 450 includes information indicating that all management target servers from a server A to a server X are movement destinations. FIG. 6 illustrates an example of information indicating that the server A is a movement destination. The server A is a server having a smallest management number, and the server X is a server having a largest management number.

The movement destination power transition management table 450 illustrates a change, that is, an increase amount of output power in a movement destination server when each container executed in the other servers is moved to the movement destination server. In the example illustrated in FIG. 6, the movement destination server is the server A. Therefore, FIG. 6 illustrates an output power change when containers of the container A to the container X are moved to the server A from the server B to the server X, respectively. The container A is a container having a smallest management number, and the container X is container having a largest management number. The number of management target servers and the number of management target containers are different or equal. A management number of the server X may be the same or may be different from a management number of the container X.

In FIG. 6, for example, a section 451 illustrates an output power change amount of the server A when a container executed by the server B is moved to the server A. The section 451 includes information on each of the container A to the container X. Further, for example, a section 455 in the section 451 illustrates information on an output power change amount of the server A when the container A is moved from the server B to the server A.

As illustrated in FIG. 6, a change in the output power caused by the container movement depends on a CPU usage rate and a memory usage rate of a container in a movement source server. Therefore, in this example, an output power change amount is managed for each combination of the CPU usage rate and the memory usage rate in a movement source server, a movement target container, and a movement source of the movement target container. An unmeasured cell stores an initial estimated value. In FIG. 6, “xxxW” represents the initial estimated value. The initial estimated value may be registered in advance by a user. An initial value of a cell may be a NULL value. The initial value of a cell is updated by an actually measured value (for example, a cell 456) obtained by actually moving a container.

In the example illustrated in FIG. 6, each of the CPU usage rate and the memory usage rate is divided into a plurality of ranges. Each cell of the movement destination power transition management table 450 indicates an output power change amount for each combination of a range of the CPU usage rate and a range of the memory usage rate. For example, the cell 456 indicates that the CPU usage rate of the container A on the server B is in the 30% range and the memory usage rate is in the 20% range, and when the container A is moved to the server A, the output power of the server A is increased by 100 W.

As described above, the management server 10 records an output power change amount in a movement destination server when a container is moved from a movement source server to the movement destination server. At this time, the management server 10 records information on the movement source server together with the CPU usage rate and the memory usage rate of a movement target container. This information is referred to in subsequent condition determination of container movement. Alternatively, one or both of the CPU usage rate and the memory usage rate of a container may be omitted, and other resource usage rates may be recorded. The information on the movement source server of a container may be omitted.

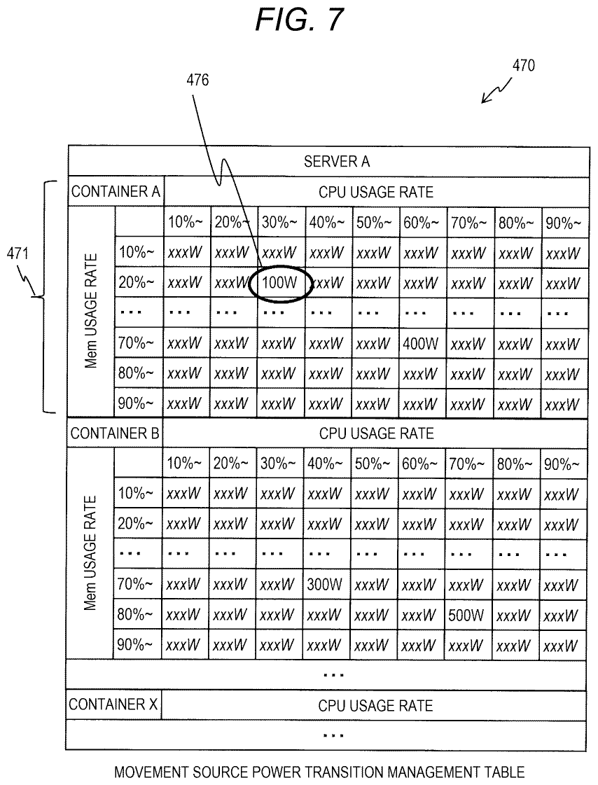

FIG. 7 illustrates a configuration example of the movement source power transition management table 470. The movement source power transition management table 470 manages a change in output power in a movement source server when a container is moved from the movement source server. In this example, the movement source power transition management table 470 stores an initial estimated value or an actually measured value of an output power change associated with container movement.

The movement source power transition management table 470 includes information indicating that all management target servers from the server A to the server X are movement sources. FIG. 7 illustrates an example of information indicating that the server A is a movement source. The movement source power transition management table 470 illustrates a change, that is, a decrease amount of output power in a movement source server when each container executed in the movement source server is moved to a movement destination server.

In the example illustrated in FIG. 7, the movement source server is the server A. FIG. 7 illustrates an output power change when each container from the container A to the container X is moved from the server A to another server. The container A is a container having a smallest management number, and the container X is a container having a largest management number.

In FIG. 7, for example, a section 471 illustrates an output power change amount of the server A when the container A executed by the server A is moved to another server. As illustrated in FIG. 7, the output power change caused by container movement depends on a CPU usage rate and a memory usage rate of a container in a movement source server. Therefore, in this example, an output power change amount in the movement source server is managed for each combination of the CPU usage rate and the memory usage rate in a movement source of a movement target container. An unmeasured cell stores an initial setting. In FIG. 7, “xxxW” represents an initial estimated value. The initial estimated value may be registered in advance by a user. An initial value of a cell may store a NULL value. The initial value of a cell is updated by an actually measured value (for example, a cell 476) obtained by actually moving a container.

In the example illustrated in FIG. 7, each of the CPU usage rate and the memory usage rate is divided into a plurality of ranges. Each cell of the movement source power transition management table 470 indicates an output power change amount for each combination of a range of the CPU usage rate and a range of the memory usage rate. For example, the cell 476 refers to that the CPU usage rate of the container A is in the 30% range and the memory usage rate is in the 20% range, and when the container A is moved from the server A, the output power of the server A is reduced by 100 W.

As described above, the management server 10 records an output power change amount in a movement source server when a container is moved from the movement source server to a movement destination server. At this time, the management server 10 records the CPU usage rate and the memory usage rate of a movement target container. This information is referred to in subsequent condition determination of container movement. Alternatively, one or both of the CPU usage rate and the memory usage rate of a container may be omitted, and other resource usage rates may be recorded.

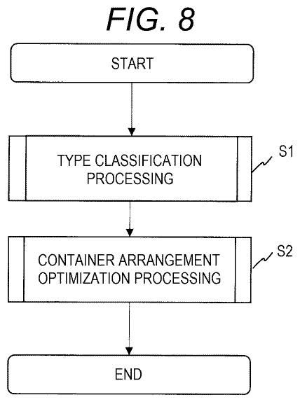

An example of processing executed by the management server 10 will be described below. FIG. 8 illustrates an overall flow of processing executed by the management server 10. After executing type classification processing S1, the management server 10 executes container arrangement optimization processing S2. The type classification processing S1 may be omitted.

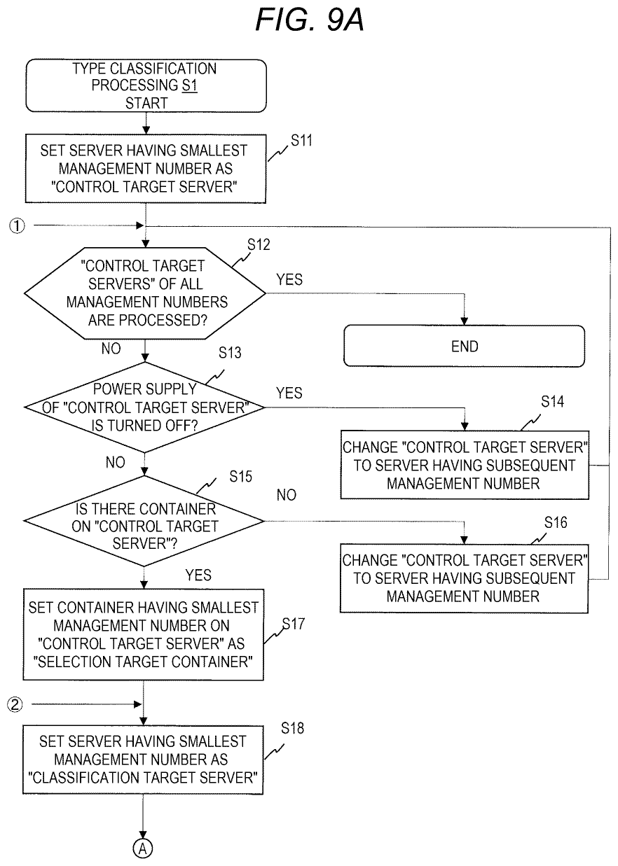

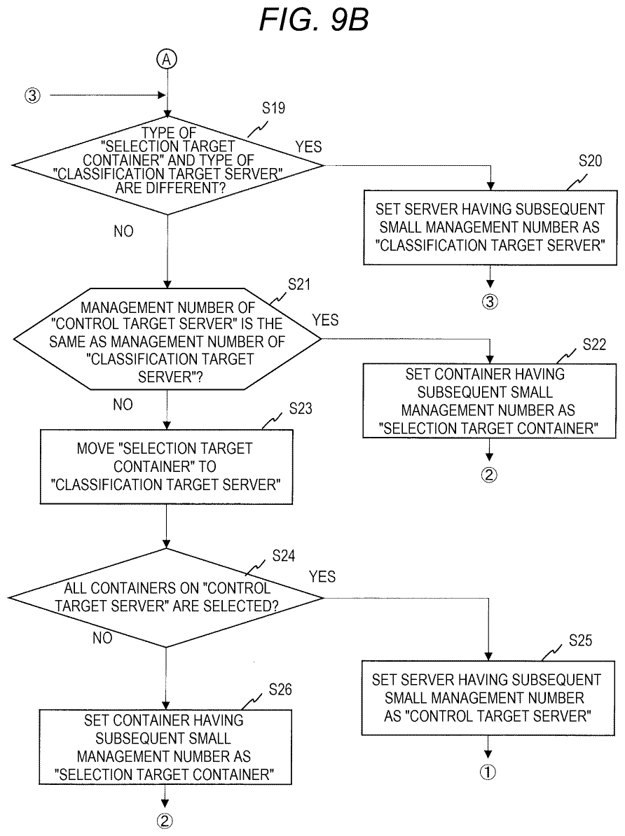

FIGS. 9A and 9B illustrate a flowchart of the type classification processing S1. In the flowchart of the type classification processing S1, containers are aggregated in servers of the same group. The management server 10 may execute the type classification processing S1, for example, at the start of operating a system or when a new container is added. The type classification processing S1 enables containers to be arranged in servers of the same group at an earlier timing.

Referring to FIG. 9A, the container rearrangement execution unit 123 sets a server having a smallest management number as a control target server based on the server management table 410 (S11). The control target server is a server to be subjected to the processing.

Next, the container rearrangement execution unit 123 refers to the server management table 410 and determines whether the present flow was executed for control target servers of all management numbers (S12). When the present flow was executed for servers of all server management numbers (S12: YES), the management server 10 ends the present flow.

When processing of the present flow is not executed for control target server of a current management number (S12: NO), the container rearrangement execution unit 123 determines whether a power supply of the control target server is turned on or off by referring to the server management table 410. When the power supply of the control target server is turned off (S13: YES), the container rearrangement execution unit 123 refers to the server management table 410 and changes the control target server to a server having a subsequent management number (S14). Thereafter, the flow returns to step S12.

Next, the container rearrangement execution unit 123 refers to the container management table 430 and determines whether a container is present on the control target server (S15). When there is no container on the control target server (S15: NO), the container rearrangement execution unit 123 refers to the server management table 410 and changes the control target server to a server having a subsequent management number (S14). Thereafter, the flow returns to step S12.

When there is a container on the control target server (S15: YES), the container rearrangement execution unit 123 refers to the container management table 430 and sets a container having a smallest management number on the control target server as a selection target container (S17). The selection target container is a movement candidate container.

Next, the container rearrangement execution unit 123 refers to the server management table 410 and sets a server having a smallest management number as a classification target server (S18). The classification target server is a server that is a candidate for a movement destination of a container in the type classification processing S1.

Referring to FIG. 9B, the container rearrangement execution unit 123 refers to the server management table 410 and the container management table 430 to compare a type of the selection target container with a type of the classification target server (S19). When the types are different (S19: YES), the container rearrangement execution unit 123 refers to the server management table 410, sets ta server having a subsequent small management number as the classification target server (S20), and returns this flow to step S19.

When the type of the selection target container and the type of the classification target server are the same (S19: NO), the container rearrangement execution unit 123 compares a management number of the control target server with a management number of the classification target server (S21). If the numbers are the same (S21: YES), the container rearrangement execution unit 123 sets a server having a subsequent small management number as the classification target server (S22), and returns this flow to step S18.

When the management number of the control target server and the management number of the classification target server are different (S21: NO), the container rearrangement execution unit 123 moves the selection target container to the classification target server (S23).

Next, the container rearrangement execution unit 123 determines whether selection was executed for all containers on the control target server (S24). When all the containers on the control target server are selected (S24: YES), the container rearrangement execution unit 123 refers to the server management table 410 and sets a server having a subsequent small management number as the control target server (S25).

When there is an unselected container on the control target server remains (S24: NO), the container rearrangement execution unit 123 refers to the container management table 430, sets a container having a subsequent small management number as the selection target container (S26), and returns this flow to step S18.

By the above processing, all containers are arranged on servers of the same group. Containers may be aggregated to servers of the same group by a procedure different from the above method.

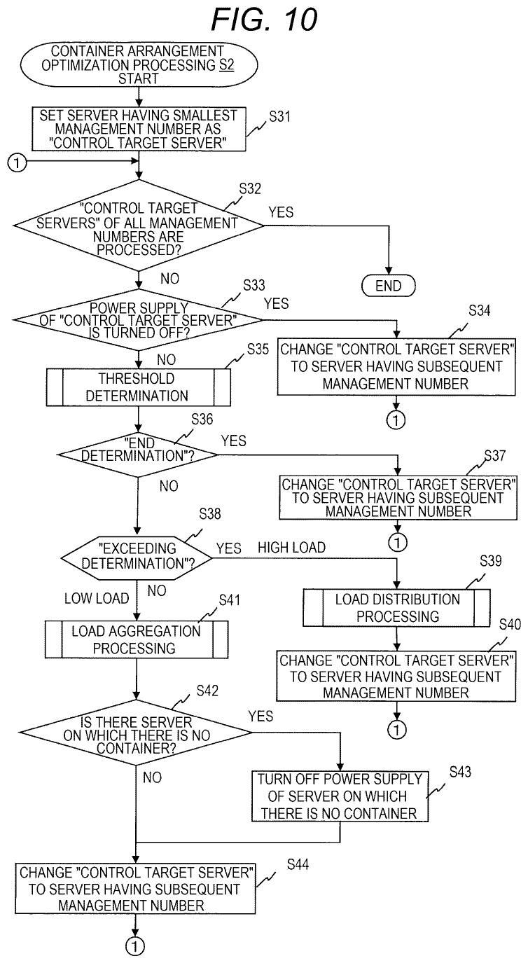

Next, the container arrangement optimization processing S2 will be described. The management server 10 executes virtual system management and control processing focusing on power supply conversion efficiency. FIG. 10 illustrates a flowchart example of the container arrangement optimization processing S2. For example, the management server 10 executes processing illustrated in the flowchart periodically. The management server 10 sequentially selects a control target server from physical servers and executes processing for container rearrangement. When the processing of a selected control target server is completed, a subsequent physical server is selected as the control target server.

First, the container rearrangement execution unit 123 sets a server having a smallest management number as the control target server based on the server management table 410 (S31). Next, the container rearrangement execution unit 123 refers to the server management table 410 and determines whether the present flow w was executed for control target servers of all management numbers (S32). When the present flow was executed for servers of all server management numbers (S32: YES), the management server 10 ends the present flow.

When processing of the present flow is not executed for a control target server of a current management number (S32: NO), the container rearrangement execution unit 123 determines whether a power supply of the control target server is turned on or off by referring to the server management table 410. When the power supply of the control target server is turned off (S33: YES), the container rearrangement execution unit 123 refers to the server management table 410 and changes the control target server to a server having a subsequent management number (S34). Thereafter, the flow returns to step S32.

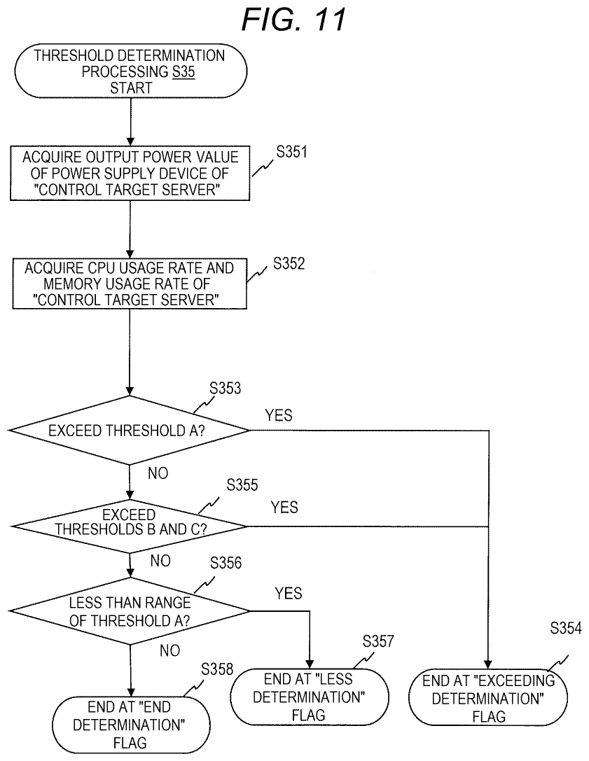

When the power supply of the control target server is turned on (S33: NO), the container rearrangement execution unit 123 executes threshold determination processing (S35). FIG. 11 illustrates a flowchart of the threshold determination processing S35.

The power supply device monitoring unit 121 acquires information on the current output power of a power supply device of the control target server from the control target server and updates the server management table 410 (S351). A state of a power supply and output power of each server are periodically acquired and registered in the server management table 410 separately from the present flow. This step may be omitted.

Next, the resource monitoring unit 122 acquires the CPU usage rate and the memory usage rate of the control target server from the control target server and updates the server management table 410 (S352). The CPU usage rate and the memory usage rate of each server are periodically acquired and registered in the server management table 410 separately from the present flow. This step may be omitted.

Next, the container rearrangement execution unit 123 refers to the server management table 410 and determines whether the current output power of the control target server exceeds the threshold A (S353). When the current output power of the control target server exceeds the threshold A (S353: YES), the container rearrangement execution unit 123 sets an “exceeding determination” flag as a threshold determination result, and ends the present flow (S354).

When the current output power of the control target server does not exceed the threshold A (S353: NO), that is, when the output power is within or smaller than the threshold A, the container rearrangement execution unit 123 compares the CPU usage rate and the memory usage rate of the control target server with the corresponding threshold B and threshold C, respectively (S355).

When either the CPU usage rate or the memory usage rate exceeds the corresponding threshold B or threshold C (S355: YES), the container rearrangement execution unit 123 sets an “exceeding determination” flag as a threshold determination result, and ends the present flow (S354).

When the CPU usage rate is equal to or less than the threshold B and the memory usage rate is equal to or less than the threshold C (S355: NO), the container rearrangement execution unit 123 determines whether the current output power of the control target server is less than the threshold A (S356).

When the output power is less than the threshold A (S356: YES), the container rearrangement execution unit 123 sets a “less determination” flag as a threshold determination result, and ends the present flow (S357). When the output power is within the threshold A (S356: NO), the container rearrangement execution unit 123 sets an “end determination” flag as a threshold determination result, and ends the present flow (S358).

As described above, when any one of the output power, the CPU usage rate, and the memory usage rate of a server exceeds a threshold, the threshold determination result is the “exceeding determination”. As will be described later, the “exceeding determination” refers to a high load state and serves as a trigger for load distribution.

When the output power is within a threshold (range) and each of the CPU usage rate and the memory usage rate is equal to or less than a threshold, it is determined that a load of the control target server is appropriate and a change of an installed container on the control target server is not necessary.

When the output power is less than a threshold and each of the CPU usage rate and the memory usage rate is equal to or less than a threshold, the threshold determination result is the “less determination”. As will be described later, the “less determination” refers to that the control target server is in a low load state, and serves as a trigger for load aggregation.

Returning to FIG. 10, the container rearrangement execution unit 123 determines whether the threshold determination result in step S35 is the “end determination” (S36). When the threshold determination result is the “end determination” (S36: YES), the container rearrangement execution unit 123 refers to the server management table 410 and changes the control target server to a server having a subsequent management number (S37). Thereafter, the flow returns to step S32. When the output power is within a range of the threshold A and the CPU usage rate and the memory usage rate are equal to or less than the thresholds B and C, the control target server is in an appropriate load state, and it is determined that container control of the control target server is not necessary.

When the threshold determination result is not the “end determination” (S36: NO), the container rearrangement execution unit 123 determines whether the threshold determination result in step S35 is the “exceeding determination” (S38). When the threshold determination result is not the “exceeding determination” (S38: NO), that is, when the threshold determination result is the “less determination”, the container rearrangement execution unit 123 executes load aggregation processing S41. The “less determination” refers to that the control target server is in a low load state.

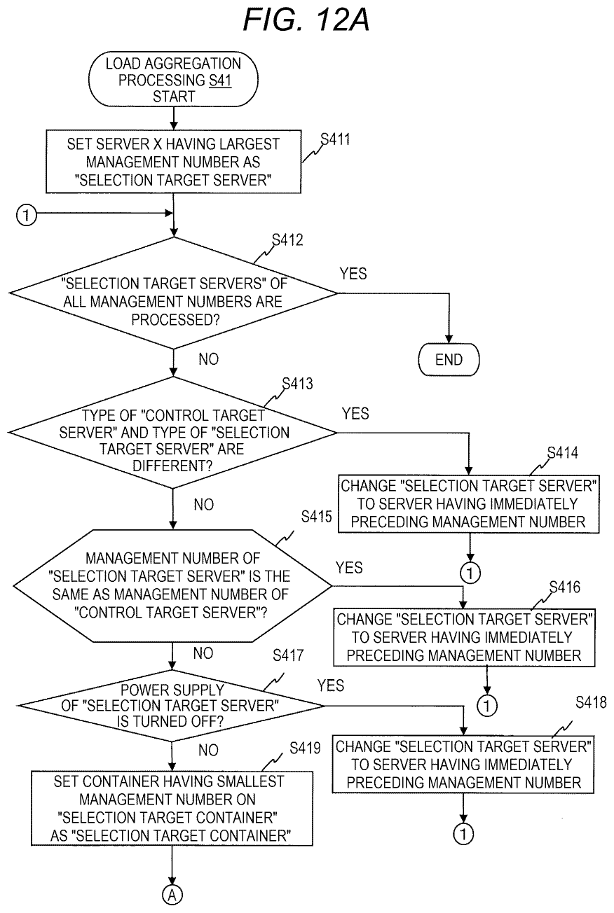

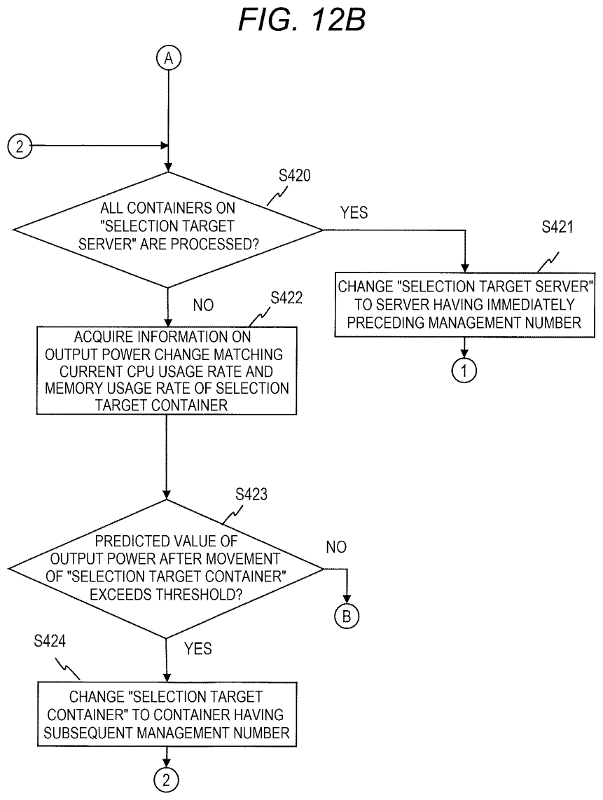

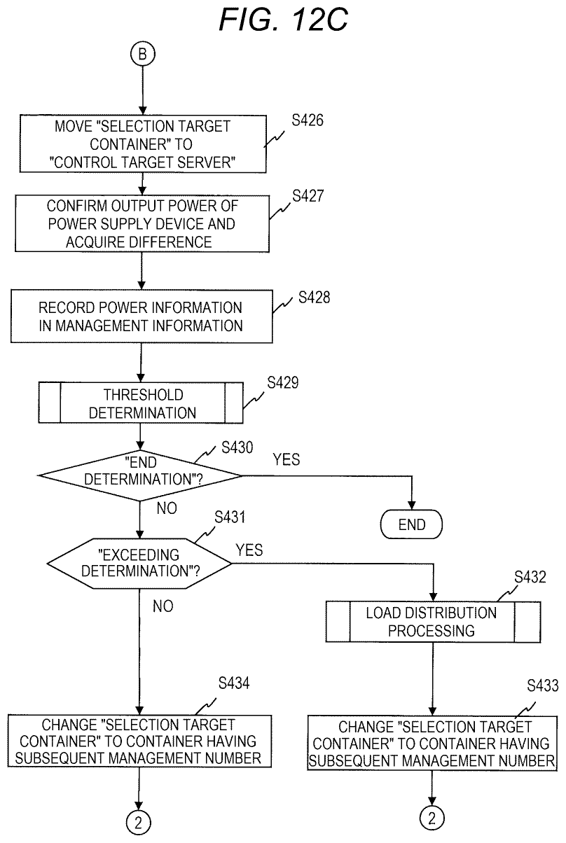

FIGS. 12A, 12B, and 12C illustrate a flowchart of the load aggregation processing S41. The load aggregation processing is processing for moving (aggregating) a container from another server to the control target server.

First, the container rearrangement execution unit 123 sets the server X having a largest management number as a selection target server based on the server management table 410 (S411). The selection target server in the present flow is a movement source candidate of a container, and the control target server is a movement destination candidate.

Next, the container rearrangement execution unit 123 determines whether the processing was executed for selection target servers of all management numbers (S412). When the processing was executed for selection target servers of all management numbers (S412), the present flow ends.

When there is an unprocessed selection target server (S412: NO), the container rearrangement execution unit 123 compares a type of the control target server with a type of the selection target server (S413). When the types are different (S413: YES), the container rearrangement execution unit 123 refers to the server management table 410, changes the selection target server to a server having an immediately preceding management number (S414), and returns the flow to step S412. In this manner, a container is prevented from being moved to a server of a different group.

When the type of the control target server and the type of the selection target server are the same (S413: NO), the container rearrangement execution unit 123 determines whether a management number of the selection target server is the same as a management number of a current control target server (S415). When the management number of the selection target server and the management number of the control target server are the same (S415: YES), the container rearrangement execution unit 123 refers to the server management table 410, changes the selection target server to a server having an immediately preceding management number (S416), and returns the flow to step S412.

When the management number of the selection target server and the management number of the control target server are different (S415: NO), the container rearrangement execution unit 123 refers to the server management table 410 and determines whether a power supply of the selection target server is turned on or off (S417). When the power supply of the selection target server is turned off (S417: YES), the container rearrangement execution unit 123 changes the selection target server to a server having an immediately preceding management number (S214), and returns the flow to step S412.

When the power supply of the selection target server is turned on (S417: NO), the container rearrangement execution unit 123 refers to the container management table 430 and sets a container having a smallest management number on the selection target server as a selection target container (S419). The selection target container is a container movement candidate.

Next, referring to FIG. 12B, the container rearrangement execution unit 123 determines whether processing of the present flow was executed for all containers on the selection target server (S420). When the processing of the present flow was executed for all containers on the selection target server (S420: YES), the container rearrangement execution unit 123 refers to the server management table 410, changes the selection target server to a server having an immediately preceding management number (S421), and returns the flow to step S412. In this manner, the selection target server is selected from physical servers excluding a physical server that was processed as the control target server. Accordingly, power and a resource usage state of the processed server can be prevented from being changed.

When the processing of the present flow was not executed for all containers on the selection target server, that is, when the processing of the present flow is not executed for a current selection target container (S420: NO), the container rearrangement execution unit 123 acquires, from the movement destination power transition management table 450, information on an output power change that matches a current CPU usage rate and memory usage rate of the selection target container in which the control target server is the movement destination and the selection target server is the movement source (S422). The acquired value is an actually measured value or an initial estimated value. The CPU usage rate and the memory usage rate of the selection target container can be acquired from the container management table 430.

Next, after the selection target container is moved from the selection target server to the control target server, the container rearrangement execution unit 123 determines whether a predicted value of output power of the control target server exceeds the threshold A (S423). That is, the container rearrangement execution unit 123 acquires an output power change amount matching a condition based on the movement destination power transition management table 450 and adds a value of the output power change amount to the current output power of the control target server. The container rearrangement execution unit 123 compares the obtained value with the threshold A indicated by the server management table 410.

When the predicted value of the output power of the control target server after movement of the selection target container exceeds the threshold (S423: YES), the container rearrangement execution unit 123 changes the selection target container to a container having a subsequent management number without moving the selection target container (S424). Thereafter, the flow returns to step S420. When the predicted value of the output power of the control target server after movement of the selection target container does not exceed the threshold (S423: NO), the flow proceeds to step S426 in FIG. 12C.

Referring to FIG. 12C, the container rearrangement execution unit 123 moves the selection target container from the selection target server to the control target server and updates the container management table 430 (S426). Further, the container rearrangement execution unit 123 acquires an output power value of a power supply device from each of the control target server and the selection target server, and calculates a difference between output power before and after movement of the selection target container (S427). The container rearrangement execution unit 123 stores the difference of the output power of the control target server in the movement destination power transition management table 450, and stores the difference of the output power of the selection target server in the movement source power transition management table 470 (S428).

Next, the container rearrangement execution unit 123 executes threshold determination processing on the control target server (S429). The threshold determination processing S224 is the same as the threshold determination processing S35 described with reference to FIG. 11.

The container rearrangement execution unit 123 determines whether the threshold determination result is the “end determination” (S430). When the threshold determination result is the “end determination” (S430: YES), the present flow ends. When the threshold determination result is not the “end determination” (S430: NO), the container rearrangement execution unit 123 determines whether the threshold determination result is the “exceeding determination” (S431).

When the threshold determination result is the “exceeding determination” (S431: YES), the container rearrangement execution unit 123 starts load distribution processing for the control target server (S432). Details of the load distribution processing will be described later. After the load distribution processing is completed, the container rearrangement execution unit 123 changes the selection target container to a container having a subsequent management number (S433). Thereafter, the flow returns to step S420.

When the threshold determination result is the “exceeding determination” (S431: YES), the container rearrangement execution unit 123 changes the selection target container to a container having a subsequent management number (S434). Thereafter, the flow returns to step S420.

As described above, in the load aggregation processing S21, servers are selected in descending order of the management number, and a container that can be aggregated in the control target server is selected. By giving priority to a server having a large management number serving as a movement source of a container, the possibility of excluding all containers from the server having a large management number increases. As a result, it is possible to increase the probability of occurrence of a server of which a power supply can be turned off. A reference value different from the management number may be used.

In the above example, in the load aggregation processing S41, it is possible to avoid moving a container for which the output power of the control target server is predicted to exceed the threshold A. Accordingly, it is possible to reduce the possibility that the output power of the control target server exceeds the threshold A. In the load aggregation processing S41, since output power change amounts of the movement source and the movement destination caused by container movement are recorded in the management information, subsequent container rearrangement can be executed more accurately.

Returning to FIG. 10, when the threshold determination result is the “exceeding determination” (S38: YES), the container rearrangement execution unit 123 executes load distribution processing S39. Thereafter, the container rearrangement execution unit 123 refers to the server management table 410 and changes the control target server to a server having a subsequent management number (S40). Thereafter, the flow returns to step S32.

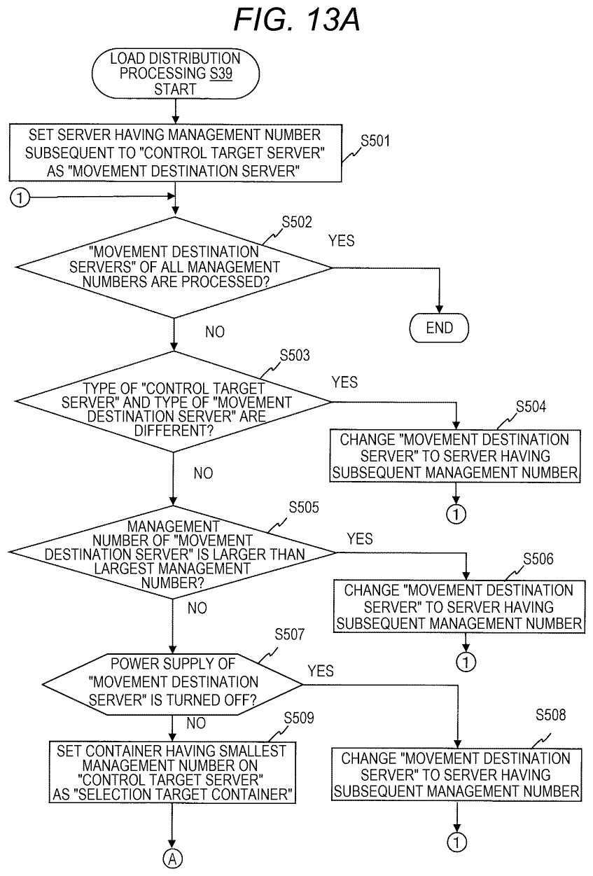

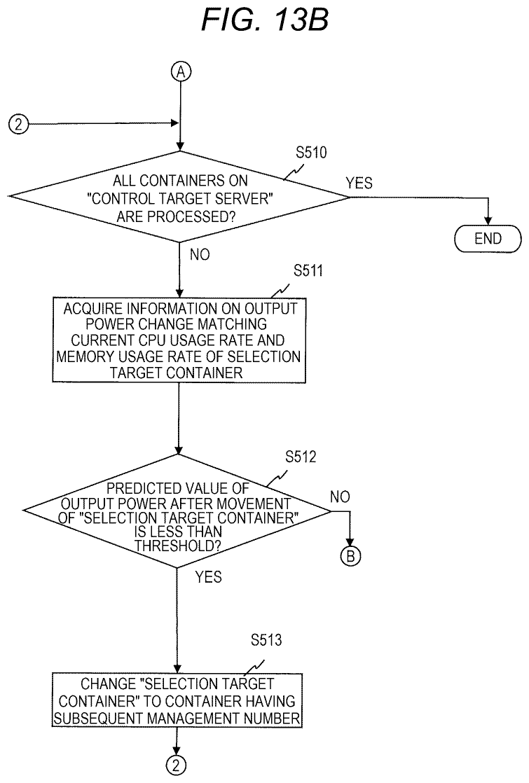

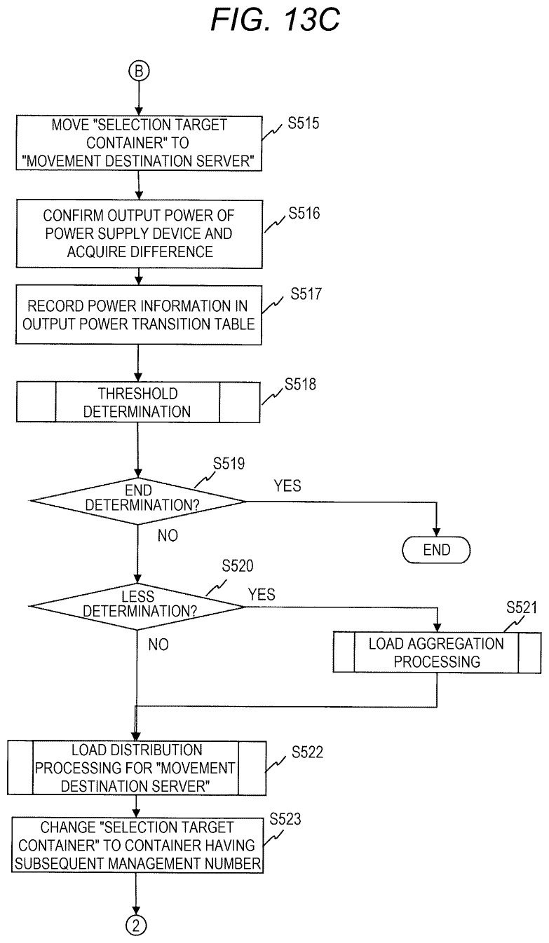

FIGS. 13A, 13B, and 13C are flowcharts illustrating the load distribution processing S39. The load distribution processing is processing for moving (distributing) a container from the control target server to another server. First, the container rearrangement execution unit 123 sets a server having a management number subsequent to the management number of the control target server as a “movement destination server” based on the server management table 410 (S501).

Next, the container rearrangement execution unit 123 determines whether processing was executed for the movement destination servers of all management numbers (S502). When the processing was executed for the movement destination servers of all management numbers (S502: YES), the present flow ends.

When there is an unprocessed destination server (S502: NO), the container rearrangement execution unit 123 compares a type of the control target server and a type of the movement destination server (S503). When the types are different (S503: YES), the container rearrangement execution unit 123 refers to the server management table 410, changes the movement destination server to a server having a subsequent management number (S504), and returns the flow to step S502. In this manner, a container is prevented from being moved to a server of a different group.

When the type of the control target server and the type of the movement destination server are the same (S503: NO), the container rearrangement execution unit 123 determines whether the management number of the movement destination server is larger than a largest management number of a server (S505). When the management number of the movement destination server is larger than the largest value (S505: YES), the container rearrangement execution unit 123 refers to the server management table 410, changes the movement destination server to a server having a subsequent management number (S504), and returns the flow to step S502.

When the management number of the movement destination server is equal to or less than the largest value (S505: NO), the container rearrangement execution unit 123 refers to the server management table 410 and determines whether a power supply of the movement destination server is turned on or off (S507). When the power supply of the movement destination server is turned off (S507: YES), the container rearrangement execution unit 123 changes the movement destination server to a server having a subsequent (immediately subsequent) management number (S508). Thereafter, the flow returns to step S502. The movement destination server is a server having a larger management number than the control target server. That is, the movement destination server is selected from physical servers other than a physical server that was processed as the control target server. Accordingly, power and a resource usage state of the processed server can be prevented from being changed.

When the power supply of the movement destination server is turned on (S507: NO), the container rearrangement execution unit 123 refers to the container management table 430, and sets a container having a smallest management number on the control target server as the “selection target container” (S509). The selection target container is a container movement candidate.

Next, referring to FIG. 13B, the container rearrangement execution unit 123 determines whether the processing of the present flow is executed for all containers on the control target server (S510). When the processing of the present flow was executed for all containers on the control target server (S510: YES), the present flow ends.

When the processing of the present flow is not executed for all containers on the control target server, that is, when the processing of the present flow is not executed for a current selection target container (S510: NO), the container rearrangement execution unit 123 acquires information on an output power change that matches the current CPU usage rate and memory usage rate of the selection target container in which the control target server is a movement source and the movement destination server is a movement destination in the movement source power transition management table 470 (S511). The acquired value is an actually measured value or an initial estimated value. The CPU usage rate and the memory usage rate of the selection target container can be acquired from the container management table 430.

Next, the container rearrangement execution unit 123 moves the selection target container from the control target server to the movement destination server, and then determines whether a predicted value of output power of the control target server is less than the threshold A (S512). That is, the container rearrangement execution unit 123 acquires the output power change amount of the actually measured value matching a condition from the movement source power transition management table 470, and subtracts the value from the current output power of the control target server. The container rearrangement execution unit 123 compares the obtained value with the threshold A indicated by the server management table 410.

When the predicted value of the output power of the control target server after the movement of the selection target container is less than the threshold A (S512: YES), the container rearrangement execution unit 123 changes the selection target container to a container having a subsequent management number without moving the selection target container (S513). Thereafter, the flow returns to step S510. When the predicted value of the output power of the control target server after the movement of the selection target container is the threshold A or exceeds the threshold A (S512: NO), the flow proceeds to step S515 in FIG. 13C.

Referring to FIG. 13C, the container rearrangement execution unit 123 moves the selection target container from the control target server to the movement destination server, and updates the container management table 430 (S515). Further, the container rearrangement execution unit 123 acquires an output power value of a power supply device from each of the control target server and the movement destination server, and calculates a difference in the output power before and after the movement of the selection target container (S516). The container rearrangement execution unit 123 stores the difference of the output power of the control target server in the movement source power transition management table 470, and stores the difference of the output power of the movement destination server in the movement destination power transition management table 450 (S517).

Next, the container rearrangement execution unit 123 executes threshold determination processing on the control target server (S518). The threshold determination processing S518 is the same as the threshold determination processing S35 described with reference to FIG. 11.

The container rearrangement execution unit 123 determines whether the threshold determination result is the “end determination” (S205). When the threshold determination result is the “end determination” (S519: YES), the present flow ends. When the threshold determination result is not the “end determination” (S519: NO), the container rearrangement execution unit 123 determines whether the threshold determination result is the “less determination” (S520).

When the threshold determination result is the “less determination” (S520: YES), the container rearrangement execution unit 123 starts load aggregation processing on the control target server (S521). The load aggregation processing S521 is the same as the load aggregation processing S41 described with reference to FIGS. 12A, 12B, and 12C. After the load aggregation processing 521 is completed or when the threshold determination result is the “exceeding determination” (step S520: NO), the container rearrangement execution unit 123 executes load distribution processing on the movement destination server (S522). Thereafter, the container rearrangement execution unit 123 changes the selection target container to a container having a subsequent management number (S523), and the flow returns to step S510.

As described above, the management server 10 selects a container for which it is estimated that the output power of the control target server does not fall below the threshold A even when the container is moved, and moves the container to a server having a subsequent management number. Further, the management server 10 temporarily moves a container having no information on the output power change in the management information, and stores the information on the output power change.

When the output power of the movement destination server exceeds a threshold due to container movement, the management server 10 executes the load distribution processing S522 on the movement destination server.

Accordingly, it is possible to prevent a load on the movement destination server from temporarily becoming extremely high. Note that this may be omitted. The load distribution processing S522 of the movement destination server may be omitted.

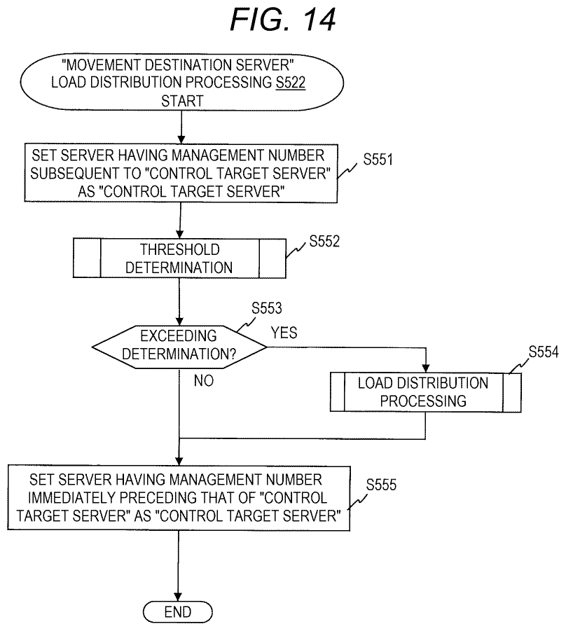

FIG. 14 illustrates a flowchart of the load distribution processing S522 of the movement destination server. The container rearrangement execution unit 123 sets a server having a management number subsequent to the current control target server as a new control target server (S551). The new control target server is the movement destination server.

Next, the container rearrangement execution unit 123 executes the threshold determination processing on the control target server (S552). The threshold determination processing S552 is the same as the threshold determination processing S35 described with reference to FIG. 11.

The container rearrangement execution unit 123 determines whether the threshold determination result is the “exceeding determination” (S553). When the threshold determination result is the “exceeding determination” (S553: YES), the container rearrangement execution unit 123 executes the load distribution processing on the control target server (S554). The load distribution processing S554 is the same as the load distribution processing S39 described with reference to FIGS. 13A, 13B, and 13C.

After the load distribution processing S554 is completed or when the threshold determination result is not the “exceeding determination” in step S553 (S553: NO), the container rearrangement execution unit 123 sets a server having a management number immediately preceding the manage number of the current control target server as a new control target server (S555). Thereafter, the present flow ends.

As described above, many containers may be moved to the movement destination server in the load distribution processing S39, and a load of the movement destination server may become extremely high. By temporarily setting the movement destination server s as the control target server and performing the load distribution processing on the movement destination, it is possible to prevent the load of the movement destination from becoming extremely high.

Returning to FIG. 10, after the load aggregation processing S41, the container rearrangement execution unit 123 searches the container management table 430 for a server on which there is no container being executed (S42). When there is a server on which there is no container (S42: YES), the container rearrangement execution unit 123 turns off a power supply of the server on which there is no container (S43). After the power supply of the server on which there is no container is turned off, or when there is no server on which there is no container in step S42 (S42: NO), the container rearrangement execution unit 123 changes the control target server to a server having a subsequent management number (S44). Thereafter, the flow returns to step S32.

As described above, in the embodiment of the present specification, in order to reduce power loss caused by power supply conversion, an output power range in which power efficiency of a power supply device is high is known in advance, and containers or virtual machines on a physical server (also simply referred to as a server) of a management target are rearranged based on the output power range. Accordingly, power consumption of a system can be reduced, and the CO2 emission amount can be reduced. In the embodiment of the present specification, containers or virtual machines are rearranged such that there is a server whose power supply can be turned off. Accordingly, power consumption can be further reduced.

In the embodiment of the present specification, output power and resource information are collected from a server, and resource rearrangement and power control are executed based on management information. In the embodiment of the present specification, containers or virtual machines are arranged such that each of a usage rate of a processor and a usage rete of a memory in a server can be maintained at a threshold or less. Accordingly, it is possible to prevent a decrease in processing performance of the server. According to the embodiment of the present specification, in a virtualization system, it is possible to achieve operation in which power consumption including power loss caused by power conversion of a power supply device is reduced, while preventing a decrease in processing performance of a server.

The invention is not limited to the embodiment described above, and includes various modifications. For example, the embodiment described above has been described in detail to facilitate understanding of the invention, and the invention is not necessarily limited to those including all configurations described above. A part of a configuration of a certain embodiment can be replaced with a configuration of another embodiment, and a configuration of another embodiment can be added to a configuration of a certain embodiment. A part of a configuration of each embodiment may be added to, deleted from, or replaced with another configuration.

Some or all of configurations, functions, processing units, and the like described above may be implemented by hardware by, for example, designing with an integrated circuit. The above configurations, functions, and the like may be implemented by software by a processor interpreting and executing a program for implementing each function. Information such as a program, a table, and a file for implementing each function can be stored in a recording device such as a memory, a hard disk, or a solid state drive (SSD), or in a recording medium such as an IC card or an SD card.

Further, control lines and information lines are those considered to be necessary for description, and not all control lines and information lines are necessarily illustrated in the product. Actually, it may be considered that almost all configurations are connected to one another.

What is claimed is:

1. A management system for managing a virtualization system, the management system comprising:
a processor; and
a storage device, wherein
the storage device stores
server management information for managing a plurality of physical servers, and
virtualization package management information for managing a plurality of virtualization packages that are installed on the plurality of physical servers and provide isolated user environments,
the server management information indicates
a current output power value of each of the plurality of physical servers,
a threshold for an output power value of each of the plurality of physical servers, and
a type of each of the plurality of physical servers,
the virtualization package management information indicates
a physical server on which each of the plurality of virtualization packages is installed, and
each of the plurality of a type of virtualization packages, and
the processor is configured to
select a control target server from the plurality of physical servers,
acquire information on an output power value and a threshold of the control target server from the server management information,
determine whether distribution of a virtualization package on the control target server to another physical server or aggregation of a virtualization package from another physical server to the control target server is necessary based on the output power value and the threshold of the control target server, and
refer to the server management information and the virtualization package management information and select a virtualization package which is a movement candidate and a physical server which is a movement destination candidate in the same group when determining that the distribution or the aggregation of the virtualization package is necessary.

2. The management system according to claim 1, wherein
the server management information indicates
a usage state of a physical resource of each of the plurality of physical servers, and
a threshold for the usage state of the physical resource, and
the processor is configured to determine whether the distribution of the virtualization package from the control target server or the aggregation of the virtualization package to the control target server is necessary based on the usage state of the physical resource of the control target server and the threshold as well.

3. The management system according to claim 2, wherein
the usage state of the physical resource includes a processor usage rate and a memory usage rate.

4. The management system according to claim 1, wherein
the storage device stores power transition management information indicating information on the virtualization package including a movement source, a resource usage state in the movement source, power usage in the movement source, and power usage in a movement destination, and
the processor refers to the power transition management information and the server management information, and when estimating that an output power value in the movement destination candidate exceeds the threshold or an output power value in a movement source falls below the threshold due to movement of the virtualization package which is a movement candidate, the processor does not move the movement candidate.

5. The management system according to claim 4, wherein
the resource usage state includes a processor usage rate and a memory usage rate.

6. The management system according to claim 4, wherein
an initial value of the power transition management information is an estimated value.

7. The management system according to claim 1, wherein
the processor is configured to
sequentially select the control target server from the plurality of physical servers to execute processing, and
preferentially select a specific physical server as a movement destination candidate in the distribution.

8. The management system according to claim 1, wherein
when there is a physical server on which the virtualization package is absent after the distribution or the aggregation, the processor turns off a power supply of the physical server.

9. The management system according to claim 1, wherein
after the virtualization package is moved, the processor determines whether the distribution of the virtualization package which is a movement destination is necessary based on an output power value of the physical server which is a movement destination and the threshold.

10. The management system according to claim 1, wherein
the processor executes type classification processing before selecting the control target server from the plurality of physical servers, and
in the type classification processing, the plurality of virtualization packages are aggregated in the physical servers of the same group with reference to the server management information and the virtualization package management information.

11. A method for managing a virtualization system by a management system, wherein
the management system stores
server management information i for managing a plurality of physical servers, and
virtualization package management information for managing a plurality of virtualization packages that are installed on the plurality of physical servers and provide isolated user environments,
the server management information indicates
a current output power value of each of the plurality of physical servers,
a threshold for an output power value of each of the plurality of physical servers, and
a type of each of the plurality of physical servers, and
the virtualization package management information indicates
a physical server on which each of the plurality of virtualization packages is installed, and
a type of each of the plurality of virtualization packages,
the method comprising:
selecting a control target server from the plurality of physical servers;
acquiring information on output power and a threshold of the control target server from the server management information;
determining whether distribution of a virtualization package on the control target server to another physical server or aggregation of a virtualization package from another physical server to the control target server is necessary based on the output power and the threshold of the control target server; and
referring to the server management information and the virtualization package management information and selecting a virtualization package which is a movement candidate and a physical server which is a movement destination candidate in the same group when determining that the distribution or the aggregation of the virtualization package is necessary,
which are executed by the management system.
